(19) United States
(12) Patent Application Publication
(10) Pub. No.: US 2011/0290057 A1
(43) Pub. Date: Dec. 1, 2011

(54) Gearbox

(75) Inventor: Steven Corcoran, Cawood (GB)

(73) Assignee: CORCOST LIMITED, Cawood (GB)

(21) Appl. No.: 13/145,233

(22) PCT Filed: Feb. 12, 2010
(86) PCT No.: PCT/GB2010/000250

§ 371 Date: Jul. 19, 2011

(30) Foreign Application Priority Data
Feb. 16, 2009 (GB) 0902436.5
Feb. 16, 2009 (GB) 0902445.6
Feb. 16, 2009 (GB) 0902446.4
Feb. 16, 2009 (GB) 0902448.0
Feb. 17, 2009 (GB) 0902618.8

(51) Int. Cl. F16H 59/02; F16H 59/00

(52) U.S. Cl. 74/473.12; 74/473.1; 74/473.3

(57) ABSTRACT

A gearbox having a housing, an actuator, a leadscrew rotated by the actuator, a rack nut threadingly engaged with the leadscrew to move longitudinally as the leadscrew rotates, a toothed section that moved with the rack nut, a shaft and a gear integral with or coupled to the shaft, and arranged such that rotation of the gear causes rotation of the shaft.

Gearboxes have been used for many years and they have many different applications. Generally gearboxes comprise four main elements: actuator; drive train; housing and output means.

The actuator places force and motion into the drive train. The actuator may be a motor connected to the drive train through suitable gearing, such as a spur, bevel, helical or worm gear.

The drive train allows the manipulation of output motion and force with respect to the input motion and force provided by the actuator. The drive train typically comprises a plurality of gears of varying parameters such as different sizes, number of teeth, tooth type and usage, for example spur gears, helical gears, worm gears and/or internal or externally toothed gears.

The gearbox housing is the means which retains the internal workings of the gearbox in the correct manner. For example it allows the actuator, drive train and output means to be held in the correct relationship for the desired operation of the gearbox.

The output means is associated with the drive train and allows the force and motion from the drive train to be applied for an application. Usually, the output means exits the gearbox housing.

The output means typically can be connected to a body whereby the resultant output motion and force from the drive train is transmitted via the output shaft to the body to impart the output shaft's motion and force upon the body. Alternatively, the output means can impart the motion and force output from the drive train to the gearbox housing whereby the output means is held sufficiently as to allow the gearbox housing to rotate.

The design and/or selection of a gearbox can require many variables to be considered. These variables can affect the four main elements, whereby each variable can be of equal or disproportionate importance. Some of the variables which can be considered are the amount of space, vibration, noise, weight, safety parameters, power consumption, efficiency, service life and cost that an application will permit and/or requires.

One known way to couple an actuator to a drive train is though a worm drive, in which the actuator operates to rotate a worm that meshes with the worm gear. The worm drive can mesh with a first gear in the drive train that is coupled to an output gear, for example an output gear provided on an output shaft. The torque provided by a worm drive arrangement will be dependent on the torque produced by the actuator and the size and/or characteristics of the worm/worm gear and the output will also depend on the gears in the drive train. For a worm drive, if a high torque output is required, an actuator with a large torque and a large worm gear will be required. If the size of the worm gear is reduced, then an actuator with a higher output will be required to provide the same output torque. This means that gearboxes including a worm drive for providing drive to the drive train are typically large. In particular, the relative output to input is limited by the size of the gearbox. If the output of the gearbox is to be varied it will require either the replacement of the worm drive and drive train as the operational capabilities of the worm drive are very narrow. This means that worm driven gearboxes are inflexible regarding their operation with narrow output ranges. Worm driven gearboxes must be manufactured with tight tolerances, making them costly, and have a tendency to generate large amounts of excess heat making them inefficient and susceptible to wear. Worm driven gearboxes are self-locking, in that the application of a force to the output side of the gearbox will not cause rotation of the worm drive. This also means that the gearbox cannot “free wheel”. This means that the worm driven gearbox is always fully engaged and therefore cannot be selectively engaged or disengaged. A worm driven gearbox is also bi-directional in that the drive works equally in both directions, meaning that when lifting or lowering a load the effective weight of the load is always being driven by the worm drive.

An alternative arrangement for coupling an actuator to a drive train is through the use of one or more regular gears, such as a bevel gear. In this case, the proportionality of the output to the input is dependent upon the ratio of the gears between the actuator and the drive train and in the drive train itself. This means that the size, and therefore the weight, of the gearbox is related to the proportionality of the gearbox, and that a gearbox having a high output compared to the input will be of a large size. With such a gearbox, it is generally necessary to change the entire drive train if the output with respect to the input is to be varied. Such gearboxes are susceptible to wear. Unlike worm driven gearboxes, gearboxes relying on gears such as bevel gears are not self-locking, and as such the application of force to the output can cause rotation at the input.

### SUMMARY OF THE INVENTION

According to the present invention, there is provided a gearbox comprising:
an actuator;
a leadscrew arranged to be rotated about its axis by the actuator;
a rack nut threadingly engaged with the leadscrew, and arranged such that rotation of the leadscrew drives the rack nut longitudinally with respect to the leadscrew;
a toothed section integral with or coupled to the rack nut for longitudinal movement with the rack nut;
a shaft; and
a gear integral with or coupled to the shaft, and arranged such that rotation of the gear causes rotation of the shaft
wherein the toothed section is arranged to mesh with the gear such that the longitudinal movement of the toothed section causes rotation of the gear.

With the gearbox according to the present invention, the rotation of the leadscrew results in the longitudinal movement of the toothed section which meshes with and causes the rotation of the shaft. In this way, the proportionality of the gearbox, i.e. the relationship between the input actuation and the output, does not limit the size of the gearbox as is the case with conventional gearboxes, such as those with worm drives or a plurality of gears.

The use of a leadscrew that rotates to move a drive rack nut meshed with the leadscrew generally linearly to drive the shaft provides a self-locking gearbox, since the movement of the drive rack nut without the rotation of the leadscrew is prevented due to the meshed arrangement of the leadscrew and drive rack nut.

The leadscrew, rack nut, toothed section and gear may be provided within a housing.

The actuator may be a motor, such as an electric motor, or could be some other form of drive which may include a manual drive, for example achieved by the manual rotation of a handle to rotate the leadscrew. Although a single actuator may be used to rotate the leadscrew, it will be appreciated that a plurality of actuators may be used, for example a plurality of motors.

The drive rack nut may include an integral threaded portion, for example an internally threaded bore, that meshes with the thread of the leadscrew. Alternatively, the drive rack nut may include a threaded insert that meshes with the thread of the leadscrew and which results in the generally linear movement of the drive rack nut.

The toothed section may be attached to the drive rack nut or be formed integrally with the drive rack nut. Where the toothed section is attached to the drive rack nut, this may assist in the assembly of the gearbox. Furthermore, preferably the toothed section may be resiliently biased with respect to the drive rack nut, for example by the inclusion of a spring between the drive rack nut and the toothed section. This can bias the toothed section into or out of meshed engagement with the gear associated with the shaft. This can help ensure reliable meshing of the toothed section with the gear during normal operation to minimise wear and/or vibration.

It is preferred that the drive rack nut and/or the toothed section are held to permit the generally longitudinal movement in a direction generally parallel to the axis of the leadscrew, but to prevent their twisting with respect to the leadscrew, for example to prevent their rotation about the axis of the leadscrew as the leadscrew is rotated about the axis. Where a housing is provided this may be achieved by a surface, such as an internal surface of the housing, abutting the drive rack nut and/or the toothed section, or may be achieved by providing a bar or tube that is aligned generally with the desired direction of movement of the drive rack nut and/or the toothed section and which is received within a recess of the drive rack nut and/or the toothed section. For example, the drive rack nut and/or the toothed section may include a though hole which receives the tube or bar.

The shaft may be the final output shaft of the gearbox, or may be coupled to a further output shaft. In this case, the shaft may be coupled directly to the output shaft, for example by connecting the output shaft as an extension to the shaft, or may be connected through a suitable transmission, for example using a drive train including a series of gears. Where such a further transmission is provided, this may introduce further proportionality between the rotation of the shaft and the rotation of the drive shaft.

The gearbox may include energy storage means arranged to store energy during at least part of the rotation of the shaft to be released during another part of the rotation of the shaft. The energy storage means may be in the form of a spring. For example, the energy storage means may store energy when the shaft is rotated in one direction, which is released when the shaft is rotated in the opposite direction to assist the rotation of the shaft in the opposite direction. Alternatively or additionally, an energy conversion means may be provided to store or convert energy from the rotation of the shaft for external use. An example of such a conversion means is a dynamo which is rotated by the rotation of the shaft causing the generation of electricity that can be used to assist with the driving of the gearbox or for other uses external to the gearbox.

The gearbox of the present invention allows the input of additional energy from an energy storage means to assist with the drive. In particular, the application of a force/motion on the toothed section or the drive rack nut and/or the gear and/or shaft can reduce the amount of force that must be applied to drive the leadscrew to move the drive rack nut along the leadscrew as well as rotate the gear and shaft. This is distinct from a worm drive arrangement in which the application of a force on the worm gear will not assist with the operation of the drive, and indeed will generally result in a force being applied between the worm and the worm gear which will need to be overcome to operate the worm drive, and will therefore increase the amount of force required to operate the worm drive. Whilst other gearbox arrangements may be able to utilise additional energy to assist with the driving of the output, these are generally not self-locking. Therefore an advantage of a preferred gearbox is that it is both able to self-lock whilst being able to utilise additional drive or energy.

A second or further actuator, leadscrew, drive rack nut, toothed section and/or gear associated with the shaft may be provided to allow additional drive of the shaft. In this case, the additional actuator, leadscrew, drive rack nut, toothed section and/or gear may be the same as or different from the actuator, leadscrew, drive rack nut, toothed section and/or gear. A plurality of gearboxes according to the present invention may be connected together to form a collective. In this case, the gearboxes may be the same or different, for example having different output properties and/or internal components.

The gearbox according to the present invention may have one or more sensors to detect operational parameters of the gearbox. The gearbox may also include processor means for controlling the operation of the gearbox, and the processor could use data from sensors, where provided, to assist with the control of the gearbox. Where the gearbox is part of a collective and/or network, data may be sent to and/or received from other gearboxes or other devices of the collective and/or network

The gearbox housing may be a single piece housing, although it is preferred that the housing comprises a plurality of components that are connectible together. In this case, it is preferred that one or more pieces of the housing are replaceable with other pieces having different properties, for example of different size. This allows the overall size of the housing to be varied depending upon the size of the components to be contained within the gearbox.

### BRIEF DESCRIPTION OF THE DRAWINGS

Embodiments of the invention will now be described by way of example only with reference to the accompanying drawings, in which:

FIG. 1 depicts a plan view of a first embodiment of a gearbox;

FIG. 2 depicts a side view of the gearbox of FIG. 1;

FIG. 3 depicts a plan view of a shaft to shaft double gearbox;

FIG. 4 depicts plan view of a back to back double gearbox;

FIG. 5A depicts a plan view of a second embodiment of a gearbox;

FIG. 5B depicted a side view of the gearbox of FIG. 5A;

FIG. 6 depicts a plan view of a double gearbox;

FIG. 7 depicts a plan view of a gearbox with at least one joint output means;

FIG. 8 depicts a plan view of a double gearbox with a joint output means with two output shafts;

FIG. 9 depicts a plan of a double gearbox with a single output means;

FIG. 10 depicts a side view of a gearbox with two actuators;

FIG. 11 depicts a front view of a double gearbox;

FIG. 12 depicts a side view of a gearbox with an extension means;

FIG. 13 depicts a plan view of a double gearbox with an attachment means;

FIG. 14 depicts a side view of the tube mounted energy means;

FIG. 15 depicts a side view of the drive train means energy means;

FIG. 16 depicts a side view of a drive gear arrangements with energy means;

FIG. 17 depicts a side view of a gear arrangement with energy means;

FIG. 18 depicts a side view of a casing with energy means;

FIG. 19 depicts a side view of an inner gearbox tube energy means with wear adjustment and minimisation means;

FIG. 20 depicts a side view of expandability with actuator means energy storage and release featuring wear adjustment and minimisation means;

FIG. 21 depicts a side view of the gearbox with energy and quick release means.

### DETAILED DESCRIPTION OF PREFERRED EMBODIMENTS

In the following description, except where otherwise stated or where otherwise apparent from the context, any reference to components being attached should be understood to cover permanent attachment, for example by welding or through the use of a bonding agent or adhesive, and removable attachment for example using a mechanical attachment such as a friction fit, bolt, screw or the like. Further, except where otherwise apparent from the context, permanent attachment may include the components being integrally formed.

In the following, where reference is made to bearings, these can be any suitable bearings which may include roller bearings, ball bearings, plan bearings or needle bearings. The bearings for any component may be the same or could be of different size and/or type.

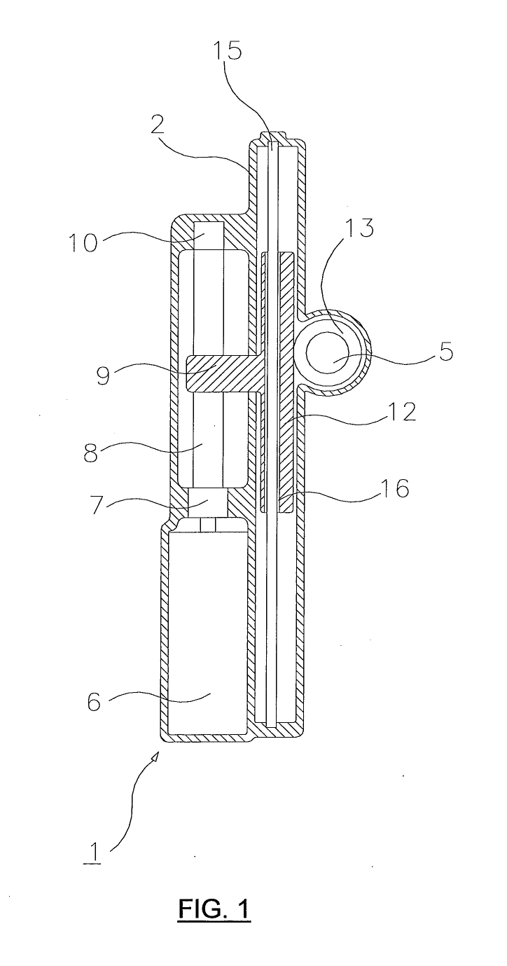

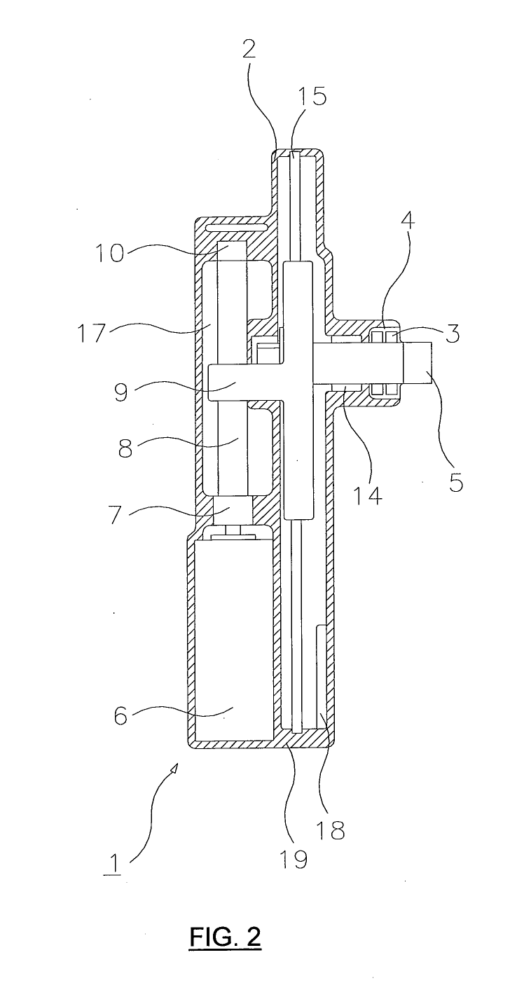

FIGS. 1 and 2 show a gearbox 1 having a housing 2. The housing 2 can be a one-piece housing or may comprise a plurality of portions that can be joined and/or sealed—for example using an adhesive, bonding agent, by welding and/or using a mechanically fixing.

The gearbox housing 2 can be of one or more portions for example three portions. Where the housing 2 includes multiple portions, these may feature inverted shapes, tapers and lip members such that when the portions are placed together effective joints are made by interlocking of the shapes, profiles, lips or tapers.

The gearbox housing 2 may be capable of magnetic and/or heat shielding, both to protect the internals of the gearbox and to minimise the external environment from any heat and/or electromagnetism. The gearbox housing 2 may also include such structural members as to be explosion and/or high pressure proof and sealed sufficiently as to be intrinsically safe.

The gearbox can be filled with an appropriate inert gas, pseudo-inert gas or mixtures thereof for particular applications and requirements, for example to provide fire protection, and may include fire resistant or retardant materials, bullet proof or high velocity projectiles proof armour, or an armoured layer.

It will be appreciated that the gearbox 1 could be provided without a dedicated housing, for example the housing being part of another device within which the gearbox 1 is provided. In this case, the other device can provide any features to allow the components of the gearbox to function as required.

The gearbox 1 is shown including an actuator 6, a leadscrew 8, a drive rack nut 9, a toothed section 12, a gear 13 and an output shaft 5.

The actuator element includes at least one gear 13 which is attached to or integrated with the shaft 5. The gear 13 can feature at least one integrated gear tooth surface. As the gear 13 is rotated, the shaft 5 will be rotated.

Where the gear 13 is integrated with the shaft 5, the gear 13 can be cut into the shaft 5. Where the gear 13 is attached to the shaft 5, the gear 13 can be secured to the shaft 5 in any suitable manner.

The shaft 5 may be mounted in the housing 2 on at least one bearing 14. The bearing 14 can be located at both sides of the shaft 5. In this example, the shaft 5 can also form the output means of the gearbox. It is also possible for the output means to comprise a further shaft section removably or permanently attached to the shaft 5.

Where the shaft 5 and/or other output means extends from the gearbox, it is preferred to include a seal which permits the rotation of the shaft 5 and/or other output means whilst avoiding the risk of contaminants passing into or out from the gearbox. As an example, an end cap 4 is provided through which the shaft 5 and/or other output means extends, the end cap including a groove to receive a seal 3 such as an O-ring or quad-ring type seal, or including an integrated seal such as a lip seal.

The actuator 6 in this example is a motor, for example an electric motor. It will be appreciated that multiple actuators, for example multiple motors, can be used, and that other actuators can be used, for example a manual actuator such as a handle, engine or the like. The actuator is attached to a leadscrew 8. This attachment can be via a coupling which can be attached to the leadscrew 8 and/or the actuator 6.

The actuator 6 can be held with cushioning means so as to maximize resistance to shock and vibration loads placed on the gearbox. This cushioning can include at least one layer of suitable material, a sealed fluid collar and/or mechanical spring means.

The leadscrew 8 is held by at least one bearing, preferably by two bearings 7, 10. These bearings are mounted in the housing 2. The bearings are shown at both sides of the leadscrew 8. The bearings allow the leadscrew 8 to be held securely whilst allowing for its low friction rotation. Force can be transmitted between the leadscrew 8 and the gearbox housing 2 via the bearings 7, 10.

The drive rack nut 9 has a threaded portion, which may be integrally formed with the drive rack nut 9 or may be provided as a separate threaded portion, for example as a threaded insert. The threaded portion meshes with the thread on the leadscrew 8 such that the rotation of the leadscrew 8 results in the longitudinal movement of the drive rack nut 9.

The drive rack nut 9 is attached to a gear toothed section 12. The toothed section 12 meshes with the gear 13. Thus the rotation of the actuator 6 results in the rotation of the leadscrew 8, which causes the longitudinal movement of the drive rack nut 9 and the consequential movement of the toothed section 12. The movement of the toothed section 12 causes the gear 13 to rotate. The rotation of the gear 13 causes rotation of the shaft 5.

The gearbox housing 2 may divide the gearbox 1 into at least one, and typically two, internal chambers 17. These chambers 17 may hold different parts of the gearbox 1, for example one chamber 17 may hold the actuator 6 whilst another chamber holds the leadscrew 8 and the drive rack nut 9.

The drive rack nut 9 and the toothed section 12 are contained within the gearbox housing 2 so as to be longitudinally slideable. A portion of the gearbox housing 2 may contact the drive rack nut 9 and/or the toothed section 12 to help retain the drive rack 9 and the tooth section 12 centred correctly with respect to the axis of the leadscrew 8, with the toothed section 12 operationally associated with the gear 13. The housing 2, the drive rack nut 9 and/or the toothed section 12 can include a low friction or lubricated surface to ensure that contact results in minimal friction whilst preventing the drive rack nut 9 and the toothed section 12 from rotating about the leadscrew 8 axis. This is referred to herein as the slide chamber captivation method and can be used in any gearbox and any embodiment of the present invention.

It will be understood that the arrangement described is self-locking. In particular, if a rotational force is applied to the output shaft 5, this will result in a longitudinal force being applied to the drive rack nut 9 through the meshing of the gear 13 with the toothed section 12. However, since the drive rack nut 9 is threadingly engaged with the leadscrew 8, the drive rack nut 9 cannot be moved longitudinally. The longitudinal movement of the drive rack nut 9 can only be achieved through the rotation of the leadscrew 8. Therefore, in the absence of any drive causing the rotation of the leadscrew 8, even where there is a rotational force applied to the output, the drive rack nut 9 cannot be moved, and therefore there will be no movement of the shaft 5 or other components of the gearbox.

In the example shown in FIGS. 1 and 2, an optional tube or bar 15 is provided. The toothed section 12 can be mounted on the tube or bar 15 to guide the movement of the toothed section 12. The tube or bar 15 can be held in the gearbox housing 2. To assist free movement of the toothed section 12 along the tube or bar 15, the tube or bar 15 and/or the toothed section 12 may include a low friction or lubricated surface, for example the tube or bar 15 being polished, and/or the toothed section 12 may include a bearing 16 located between the toothed section 12 and the tube or bar 15. This assists the toothed section 12 to slideably move with minimum friction on the tube or bar 15.

The tube or bar 15 can assist or be solely responsible for the meshed relationship between toothed section 12 and the gear 13, as well as the preferred relationship that the drive rack nut 9 and the toothed section 12 have with the leadscrew 8. The tube or bar 15 allows the toothed section 12 to slideably move longitudinally whilst keeping the toothed section 12 at the correct geometric position and contact relationship with the gear 13 for the transmission of force and motion to the gear 13. This relationship between the tube or bar 15 and the toothed section 12 can be preset for the correct contact pressure and/or can be continually optimised for the desired contact pressure between the toothed section 12 and the gear 13.

The interaction by the tube or bar 15 with the toothed section 12 and therefore the drive rack nut 9 can also inhibit the rotation of both around the leadscrew 8, and can set and/or maintain the correct contact pressure between the drive rack nut 9 and the leadscrew 8 with respect of their meshed arrangement.

The relationship between the gearbox housing 2 and the leadscrew 8 in the example shown provides a direct association between the toothed section 12 and the gear 13. The pressure between the toothed section 12 and the gear 13 can be varied by varying the geometry of the gearbox housing 2, the actuator 6, the leadscrew or other components of the gearbox.

At least one of the interactions referenced above ensures that force and motion can be transmitted to the gear 13 by the drive rack nut 9 via the toothed section 12.

The gearbox housing 2 has at least one portion and typically the housing 2 has at least three portions, including at least a left portion, a right portion and a centre portion. The main difference between gearboxes 1 for different applications is the width of the gear and the number of actuators. As an example, the higher the force typically the wider the gear 13 and the more actuators 6. Therefore the gearbox housing 2 can be configured such that the only difference between a higher force gearbox and a low force gearbox is the width of the gears, and therefore the width of the centre portions of the housing 2.

Where the gearbox housing 2 includes chambers 17, these can be formed within a single portion or within multiple portions, and can be defined using further components as required. Further portions can be provided which may be independent of the gearbox chambers. An interior webbing may be provided to form a chamber 17.

The gearbox 1 may include electronic or computer control or monitoring, and this may be implemented using hardware, firmware, software or a combination of these. A gearbox 1 may communicate through wired or wireless communication with other gearboxes or other components, such as servers or computers, and this can be used to exchange data including new programs and/or other software updates.

The gearbox 1 can include suitable electrical means 18, for example sensor mean(s), electrical connection(s), electronic circuit(s), wiring loom(s), programmable or not programmable circuit board(s), microchip(s) and/or other component(s) or assembly capability.

Where provided, the sensor means can include sensors or sensor arrays to sense parameters such as torque, power consumption and/or electrical characteristics. It is further possible that the sensors could include lubrication sensors that allow the gearbox 1 to divert lubrication to a required location.

The gearbox housing 2 can incorporate visual data screens as well as LEDs or other light emitting components or assemblies to display information about the gearbox 1.

The electronic control and/or sensing allows a number of gearboxes and/or other devices to be provided in a network and to allow them to be operated together effectively.

A number of gearboxes according to embodiments of the present invention can advantageously be connected together to form a collective. In the most simple arrangement, two like gearboxes can be coupled together, although any number and type of gearboxes can be couple together as desired.

When in a network, the gearboxes are able to process, exchange and/or store programs and data for/with other gearboxes, devices, computer means, electronic devices and/or electrical human interaction device.

The gearboxes can have a unique computer readable address, name and/or other unique identifier that can be used to not only identify the capabilities of the gearbox but also certificate and authenticate the gearbox.

The gearboxes can have a computer readable data storage means that can store information such as the capabilities of the gearbox, when it was last serviced and/or inspected, when it was manufactured and any and/or all other parameters and/or programs deemed relevant.

The gearbox is able to send information relating to the gearbox or its operation to other gearboxes or other devices such as computers, for example to allow the other gearboxes or other devices to determine how they should operate or to determine how the gearbox itself should be operated. The gearbox is also able to receive information, for example from sensors of the gearbox or from external sources, such as other gearbox or other devices such as computers to control the operation of the gearbox based on this information.

The gearboxes are able to assess the operation they are being requested to complete against at least one installed program and compare and/or modify their operation against any parameters that are associated with at least one network they are held within and/or connected to, their location, the at least one operation, the at least one body and/or other upon which they are acting and/or interacting and/or associated with.

The gearboxes are able to send and receive error messages whereby they are able to send data and receive data if the programmed parameters and/or mechanical systems have been exceeded, enacted, fulfilled or not fulfilled.

The gearboxes are able to send and receive data with regards to alerts and/or alarms, the gearboxes can send data with regards to temperature and/or air quality and/or receive information and depending on the respective location or give a human and/or machine readable warning. In the case of human interaction this would for example be an audio and/or visual warning.

Any gearbox or other connected device such as a computer can be arranged to take charge of the network and be the central data processing, sending and receiving communication node, or to take charge of a sub network and be the central data processing, sending and receiving communication node for that sub network.

If any parameter and/or mechanical system has been exceeded, enacted, fulfilled or not fulfilled, the gearboxes can inhibit usage unless an override key is used.

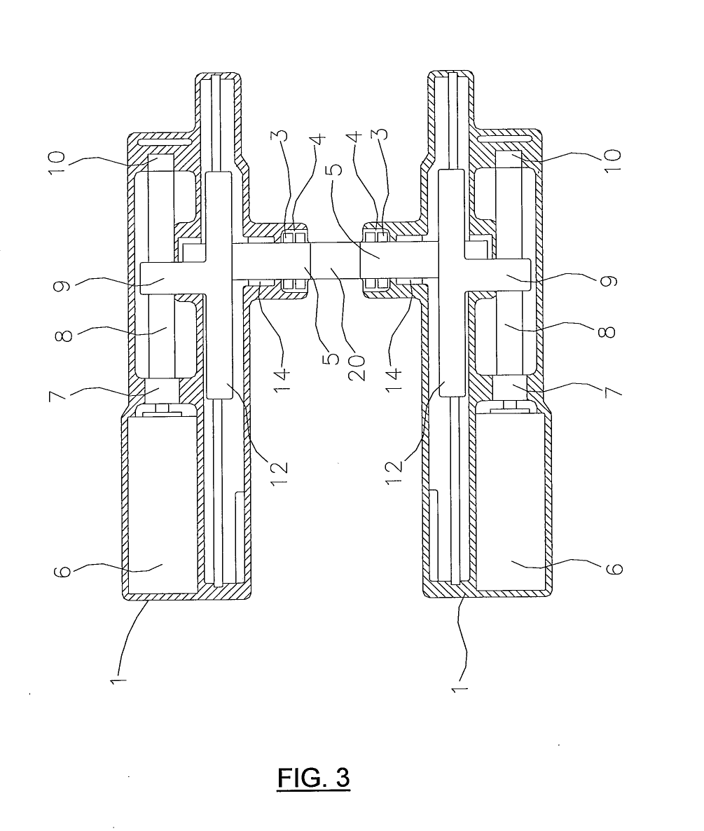

FIG. 3 shows a collective where two gearboxes 1 according to the first embodiment of the invention are coupled to each other. In this case the gearboxes 1 are coupled by the shaft 5 and/or other output means to form a collective output means 20. Each gearbox can work independently, although typically the gearboxes work together. The gearboxes can share the same housing 2 or can have separate housings 2. The gearboxes 1 can work harmoniously together even if the respective internals of the gearboxes 1, such as the drive train, actuator element, and/or outputs means as well as motion and force outputs and inputs are different, even if the gearboxes 1 are not the same. This is of an advantage that cannot be equalled by other known gearboxes.

Each gearbox 1 can have a different output means not only in terms of force and motion but also with regards to the size and shape. The gearboxes 1 can be attached to each other in axial alignment with relation to the output means 5 as shown in FIG. 3, or may be coupled in a non-axially aligned manner, or at an angle to each other.

As with all the gearboxes, the output means 20 can feature different shapes and/or formats at any point along its length. For example this could be hexagonal or oval. The output means can also carry electrical means 18 for coupling data and/or electrical power between the devices. This electrical connection can also be used to confirm that the gearboxes are connected together.

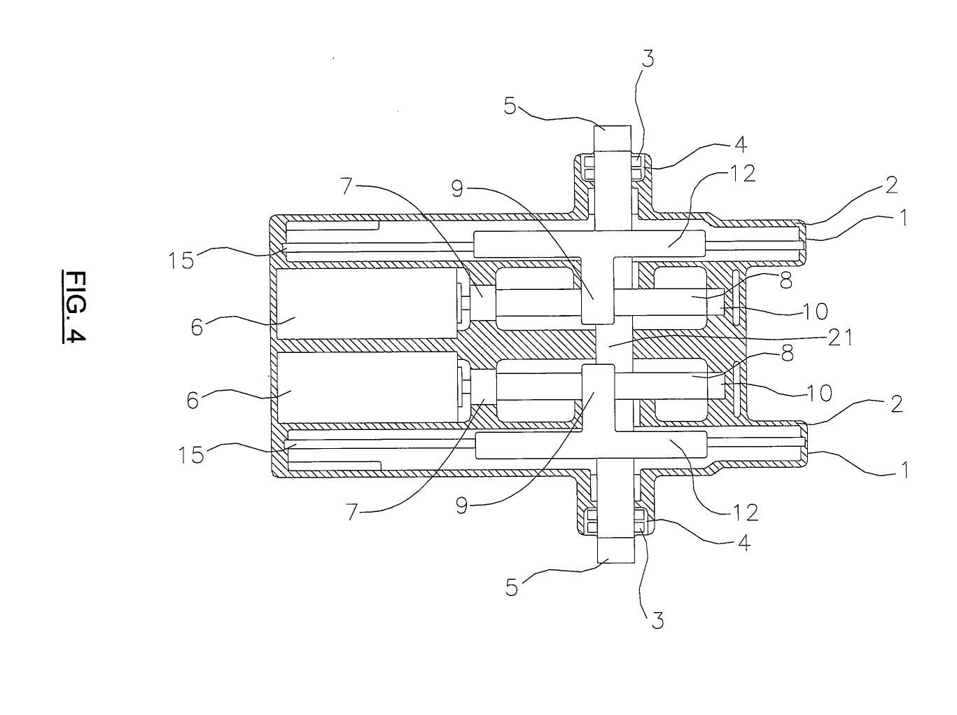

FIG. 4 shows a different collective configuration. This collective can have all the same functions, features and capabilities as the collective in FIG. 3, however in this configuration the gearboxes 1 are placed back to back with the shafts 5 attached about section 21. In some embodiments, the shafts 5 are not connected together.

As with the arrangement shown in FIG. 3, the gearboxes 1 of FIG. 4 may be coupled in an axially aligned or offset manner, and are able to communicate with each other as required.

It is possible to couple further gearboxes 1, for example to couple an additional gearbox to one of the gearboxes shown in FIG. 4 in a manner as shown in FIG. 3 to form at least a triple collective. A still further gearbox 1 can be coupled to the other gearboxes of the collective as shown in FIG. 4 in a manner as shown in FIG. 3 to form a collective of at least four gearboxes 1. Further gearboxes can be added in varying manners as shown in FIGS. 3 and 4 to form long chains of gearboxes, for example forming a chain of gearboxes 1 that alternate between the FIG. 3 arrangement and the FIG. 4 arrangement. This would form a live chain and/or live cam shaft.

The output means 5 from one gearbox can be independent or independently movable to that of another gearbox 1, and in the case of the latter the output means 5 can be movably attached. If the gearboxes 1 are to work individually they can have separate output means 5 which are not joined to section 21. Where the output means 5 are arranged to work independently whilst attached, this can be achieved using a captivated bearing. In this form the output means 5 of the gearboxes 1 would be used in a manner that allows them to rotate differently, at different motions and forces in different directions and in either axially or non-axially aligned. For example, the output means 5 can be joined and thus the movement is a summation of both actuators and drive trains and if joined they can be attached at the centre 21.

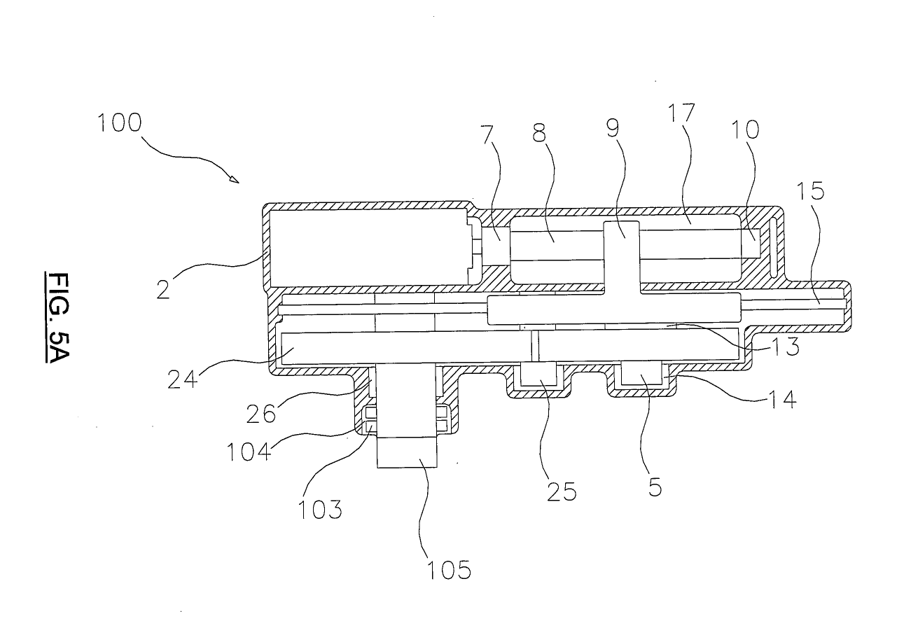

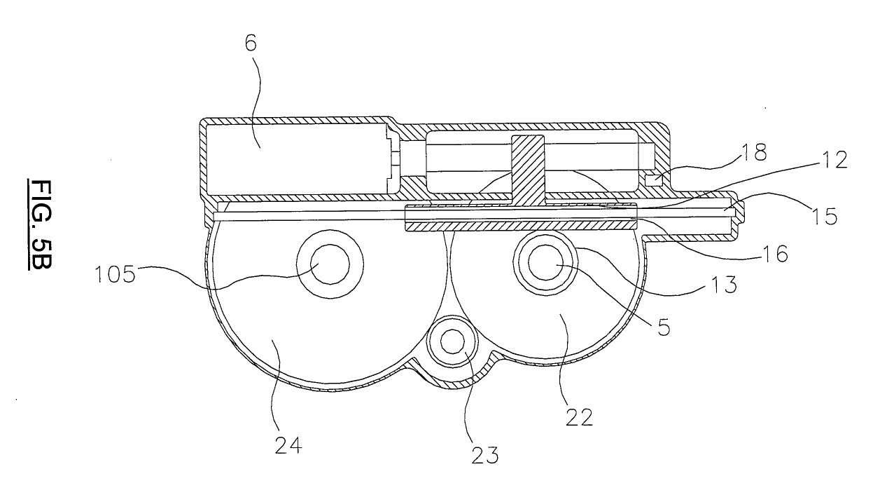

FIGS. 5A and 5B shows a second embodiment of a gearbox 100. FIG. 5A shows a plan view and FIG. 5B shows a side view.

The gearbox 100 is similar to the gearbox shown in and described with respect to FIGS. 1 and 2. Therefore the numbering used is the same as for FIGS. 1 and 2 for the same components, and the description, alternative features and functions of the basic gearbox as described with respect to FIGS. 1 and 2 are not repeated.

The main difference between the gearbox 100 and that shown in FIGS. 1 and 2 is that of a drive train, such as additional gears, coupling the driven shaft 5 to a separate output shaft 105. In the example shown, the gear 13 is provided on shaft 5 which includes the first gear of the drive train, drive gear 22. The drive gear 22 meshes with an intermediate gear 23 provided on shaft 25, which in turn meshes with an output gear 24 provided on an output shaft 105 and in this case concluding the drive train. The output shaft 105 may extend through an end cap 104 similar to end cap 4 of the first embodiment, with seals 3 as required, for example as described with respect to the first embodiment.

The gears can each be integrally formed on their respective shafts, or be attached to the shaft.

As gear 22 and gear 13 share the same shaft, the linear movement of the drive rack nut 9 and thus the toothed section 12 resulting in the rotation of gear 13 causes rotation of gear 22. The gear 22 is meshed with gear 23 and thus the rotation of gear 22 results in rotation of gear 23 which is in turn meshed with the gear 24. The gear 24 therefore rotates and therefore rotates the output shaft 105 on which it is provided.

Each of the shafts 5, 25, 105 may be mounted on suitable bearings.

As with the first embodiment, it will be appreciated that the gearbox 100 may include sensors and other electrical devices, may include software, communications systems for communicating in a wired or wireless manner, can include indicators, an arrester system and an energy storage system.

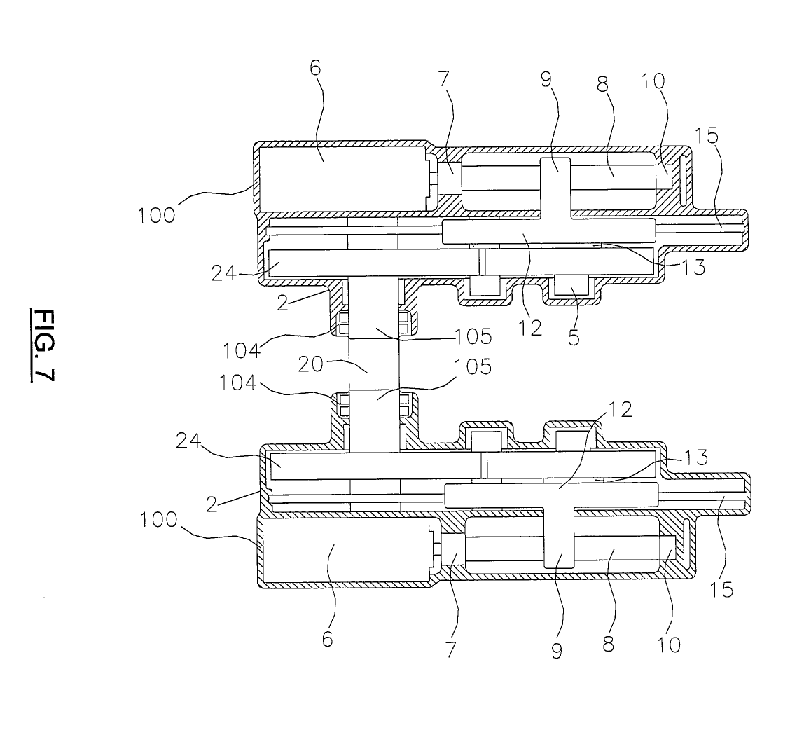

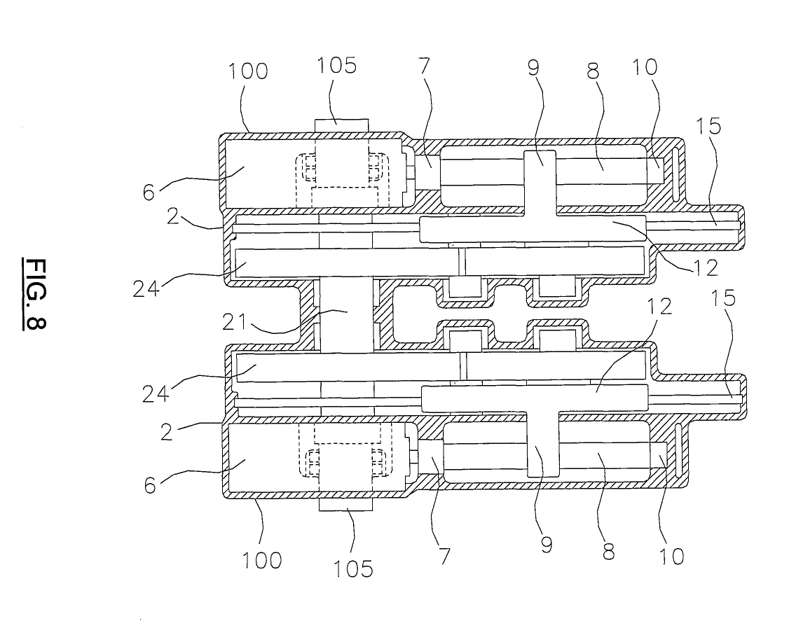

Like all embodiments, the gearbox 100 can become part of a collective of a plurality of gearboxes, for example being connected in a similar manner as shown in and as described with respect to FIG. 3 and FIG. 4. These arrangements are shown in FIGS. 7 and 8 respectively.

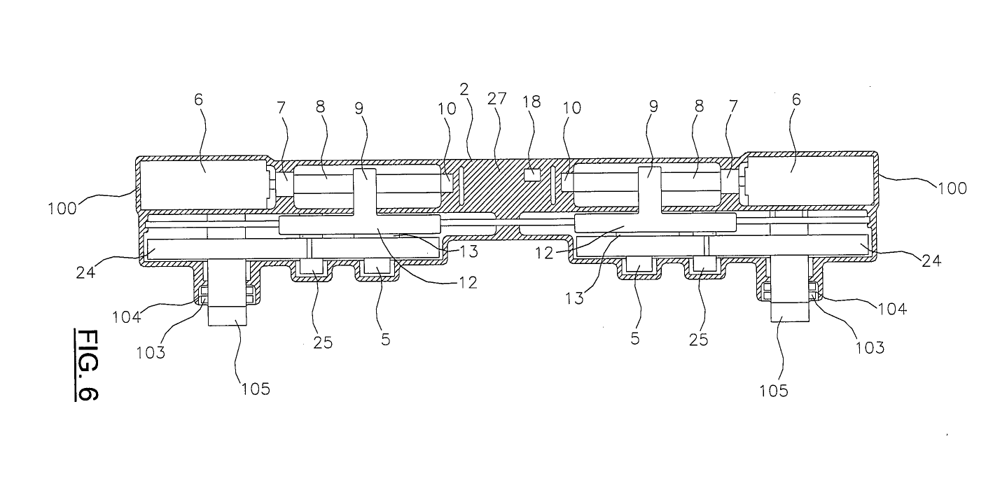

FIG. 6 shows a further collective arrangement using gearboxes 100 according to the second embodiment of the present invention. In this case, the gearboxes 100 are attached at an edge 27 of the gearbox housings 2. The leadscrews 8 and actuators 6 of the gearboxes do not connect and/or touch and as such each gearbox 100 can operate independently. At least one of the gearboxes 100 can contain an electrical means 18 whereby each of the gearboxes 1 can work together in that they can operate with relation to each other but independently of each other. The collective is shown with each gearbox 100 in the same plane, however one gearbox 100 can be in a different plane to the other gearbox 100. It will be appreciated that additional gearboxes 100 can be connected using this arrangement.

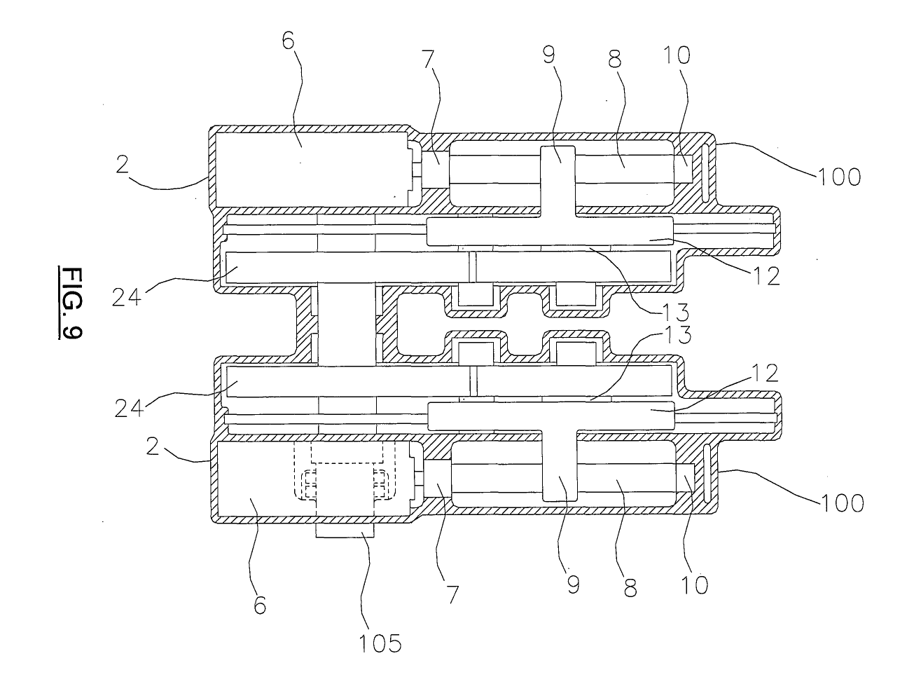

The arrangement shown in FIG. 9 is generally the same as that of FIG. 8, however there is a single output means 105 located at one side of the gearbox 100. This arrangement can be used with other embodiments of the invention and shows that at least one output means can be capped off whilst another output means is not. The non-capped output means can be attached to an attachment 28, to another gearbox 1, body and/or other item as required. The non-exit and/or capped off side can provide support to the gear and/or gear shaft 24 and/or 13 and/or shaft 105 via at least one bearing.

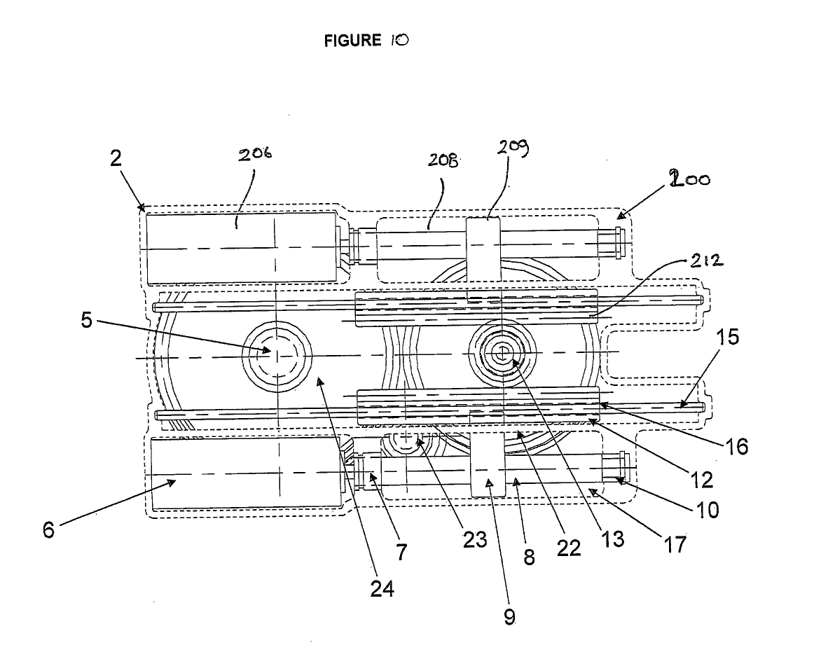

FIG. 10 shows a third embodiment of a gearbox 200. The basic features and operation of this gearbox 200 are the same as those of the second embodiment, and therefore the description with relation to these common features is being omitted for clarity.

The main difference between the gearbox 200 of the third embodiment and the gearbox 100 of the second embodiment is the provision of an additional actuator 206, leadscrew 208, drive rack nut 209 and toothed section 212 that act on the gear 13. The additional actuator 206, leadscrew 208, drive rack nut 209 and toothed section 212 are each as generally described with respect to the first example of the present invention, although it will be appreciated that in the arrangement the first actuator 6 may be different from the second actuator 206, the first leadscrew 8 may be different from the second leadscrew 208, the first drive rack nut 9 may be different from the second drive rack nut 209 and/or the first toothed section 12 may be different from the second toothed section 212. In particular, where the first and second toothed sections 12, 211 mesh with opposite sides of the gear 13, these will be arranged to move in opposite directions to rotate the gear 13. For example the second actuator is simply the inverse of the first actuator.

Where provided, features such as the engagement of the housing 2 to retain components in position, the inclusion of a tube or bar 15, bearings for the leadscrew and/or shafts, energy store, lubrication means and/or arrester can be different for the two sides of the gearbox, and can comprise some or all of the features as described with respect to the first and second embodiments of the application, or as described below.

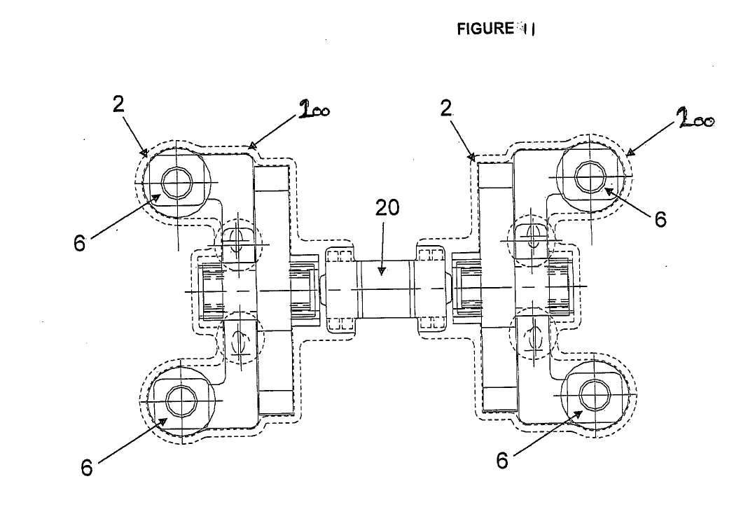

FIG. 11 shows an end view of a collective comprising two gearboxes 200 of the second embodiment connected in the general arrangement as shown in FIGS. 3 and 7. It will be appreciated that other gearboxes 200 can be connected in a collective, and that these may be connected in any suitable manner as described with respect to the first and second embodiments of the invention.

It will be appreciated that the first embodiment of the invention may also contain two sets of actuators, leadscrews, drive rack nuts and toothed sections to act on the gear 13 in a similar manner to that described with respect to FIG. 10.

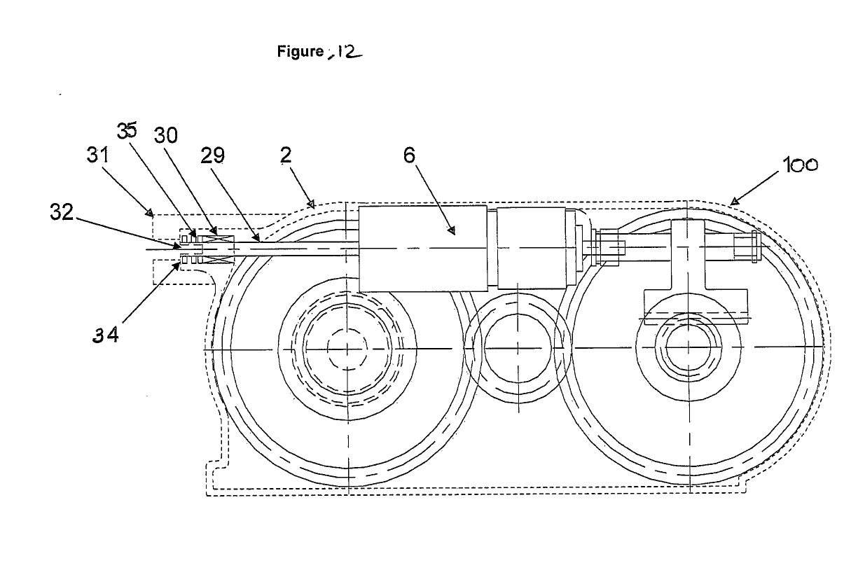

The gearbox may include a coupling to permit the actuation of the gearbox from outside the gearbox housing 2. An example of such an arrangement is shown in FIG. 12 with respect to the gearbox 100 of the second example of the invention. It will be appreciated that a similar arrangement could be used in connection with the first or third embodiments described above. An extension shaft 29 extends from the actuator 6 to a coupling 32 that allows connection to an external actuator. As shown in FIG. 12, bearings 30 can be provided to assist the free rotation of the shaft 29 and coupling 32. The coupling 32 can be provided inside or outside the housing 2, for example within an open extension 31 of the casing, which may include an end cap 35 having seals 34. A similar extension shaft 29 and coupling 32 may be associated with any actuator 6 of the gearbox, and/or with any leadscrew 8 of the gearbox.

The extension means allows for additional driving force to be placed into the system, for example by coupling a motor, such as an electric motor to the extension shaft 29. Alternatively external actuation can be used as the sole actuator, and in this case no internal actuator need be provided. The actuation may be manual actuation for example a handle for human powered force and motion input. Furthermore, the actuation could be provided from another gearbox, for example via the output means 5 of another gearbox such as described in this application.

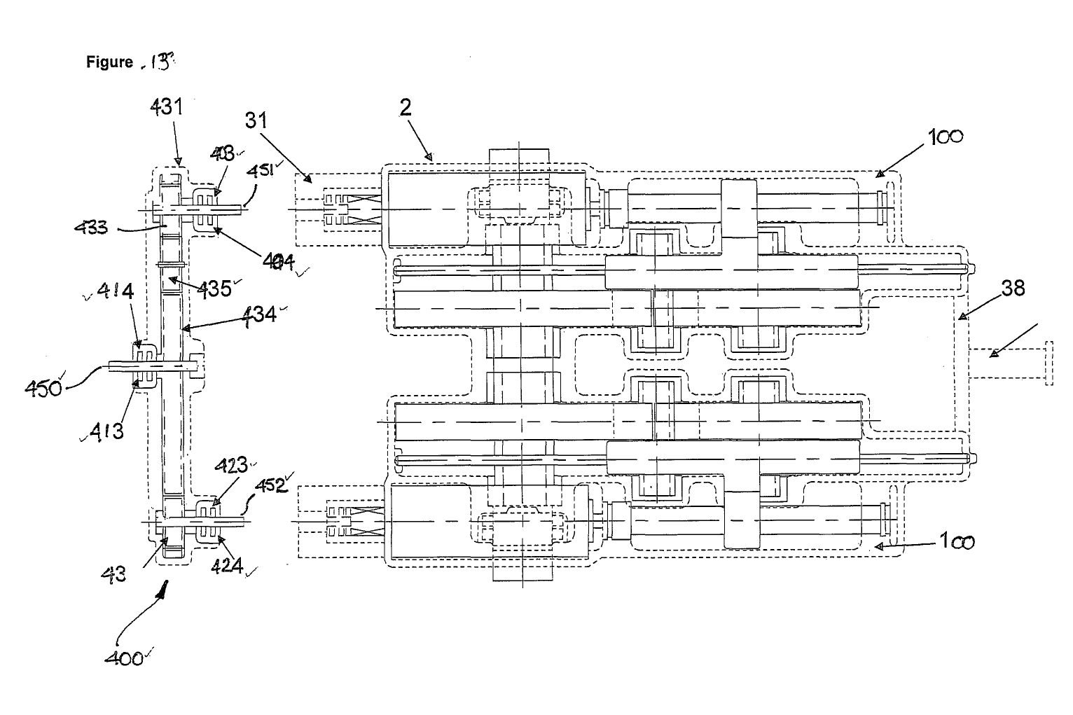

FIG. 13 shows a pair of gearboxes 100 as shown in FIG. 12 coupled to form a collective as shown in FIG. 8, in which each of the gearboxes 100 include the coupling for external actuation. In addition, an adapter 400 is provided to simultaneously apply actuation to the two gearboxes via their respective couplings to permit manual and/or electronic operation from one rotational point. It will be appreciated that this concept can be used to actuate more gearboxes if required.

The adapter 400 has an input shaft 450 and two output shafts 451, 452 which are arranged such that one output shaft 451 rotates in an opposite direction to the other output shaft 452. It will be appreciated that in other embodiments, the two output shafts may be arranged to rotate in the same direction, and that in still further embodiments further output shafts are provided which can rotate in the same or in opposite directions to other output shafts. For example, the adapter 400 may include four output shafts, where two rotate in one direction and the other two rotate in the opposite direction.

In the example shown in FIG. 13, the adapter includes an adapter housing 431 from which the input shafts 450 and the two output shafts 451, 452 extend. As described previously with respect to the shafts extending from the gearbox housing, end caps 414, 404, and 424 including seals 413, 403, and 423 may be provided through which the respective shafts 450, 451, and 452 extend whilst sealing the adapter housing. A drive gear 434 is associated with the input shaft 450. The drive gear meshes with a first intermediate gear 435 which in turn meshes with a first output gear 433 associated with the first output shaft 451. Accordingly, as the input shaft 450 is rotated in a clockwise direction, this will cause the rotation of the intermediate gear 435 in a counter-clockwise direction, which will in turn cause the rotation of the first output gear 433 and the first output shaft 451 in a clockwise direction. At the same time, the meshing of the drive gear 434 with the second output gear 436 will cause the second output gear and therefore the second output shaft 452 to rotate in a counter-clockwise direction. The inclusion of additional intermediate gears can be used to cause different rotation of the output shaft, and the addition of gears can be used to provide rotation of additional output shafts.

As described with respect to the gears of the gearbox previously, the gears may be formed integrally with the shafts, or may be attached to the shafts. Further, the adapter housing 431 can retain the components in position to ensure that they mesh to operate as required.

Bearings may be provided for the shafts. As described with respect to the gearboxes, the adapter 400 may include suitable lubrication to assist with the smooth rotation of the gears, may include an energy storage unit to store energy for use in assistance of the further movement of the adapter, and may include electronic means, sensors, indicators, networking components and the like as described with respect to the gearboxes.

The drive gear 434 will typically be larger than the output gears 433 and 436 and therefore the output shafts 451, 452 will rotate faster than the input shaft 450. The output shafts 451, 452 can be integrated with the extension portions 31 of the gearboxes.

The end of the input shaft 450 is made such that an actuator can be attached to it, for example to connect an electrical rotation means or a manual rotation aid such as a handle.

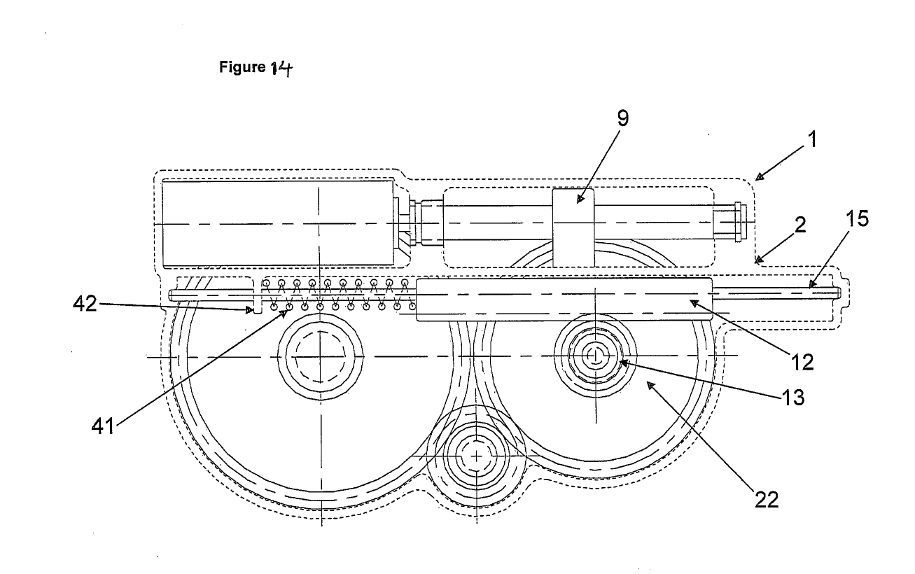

FIGS. 14 to 18 show examples of energy storage means. Although the energy storage means is shown in the context of a gearbox of the second embodiment, it will be appreciated that the energy storage means can be used with the gearbox of any embodiment of the present invention.

In at least one application the gearbox 1 can include a means to recover and/or store energy from the movement in one direction which can be released during movement in the opposite direction and/or during continuation of movement in the same direction. It is possible that the energy storage and/or release could occur at particular points in the rotation—for example energy could be stored in the middle part of the rotation to be released at the start or end of the rotation to provide an initial or final energy boost. This can reduce the total energy consumed by the actuator compared to the total energy that would have been consumed by the actuator without any energy recovery and/or storage and/or its subsequent release. This may also or alternatively allow the force, motion and acceleration of the output means to be increased using the stored energy independent of the actuator with no increase in energy consumption from the actuator.

As described with respect to the first and second embodiments, the gearbox 1 can feature at least one tube or bar 15 associated with the toothed section 12. As shown in FIG. 14, the tube or bar 15 can be associated with an energy storage means 41. A mechanical energy means in the form of a spring is shown, however a fluid energy means such as a hydraulic, pneumatic or an electrical means can be employed.

As the actuator operates and causes the toothed section 12 to move via the leadscrew 8 and drive rack nut 9 in one direction, energy is stored by the energy storage means 41. As the toothed section 12 is moved in the other direction, energy stored in the energy storage means 41 is released to assist the movement. For example, where the energy storage means is a compression spring, movement of the toothed section 12 to the left as shown in the Figure will compress the spring, thereby storing energy in the spring. When the toothed section 12 is to move in the opposite direction, the energy stored in the spring is released as the spring expands. Where the energy storage means 41 is an extension spring, movement of the toothed section 12 to the right extends the spring storing energy that is released as the toothed section 12 moves in the opposite direction.

The use of the energy storage means 41 to store energy when the gearbox is driven in one direction that is released when the gearbox is driven in the opposite direction is particularly useful where external energy is available for storage. For example, the gearbox may be used to drive a lift mechanism. In this case, driving the gearbox in one direction will raise a load, whilst driving in the opposition direction can lower a load. The energy storage means can store energy during the lowering of the load (where gravity assists the lowering), which can be released during the raising operating (where gravity acts against the operation of the gearbox).

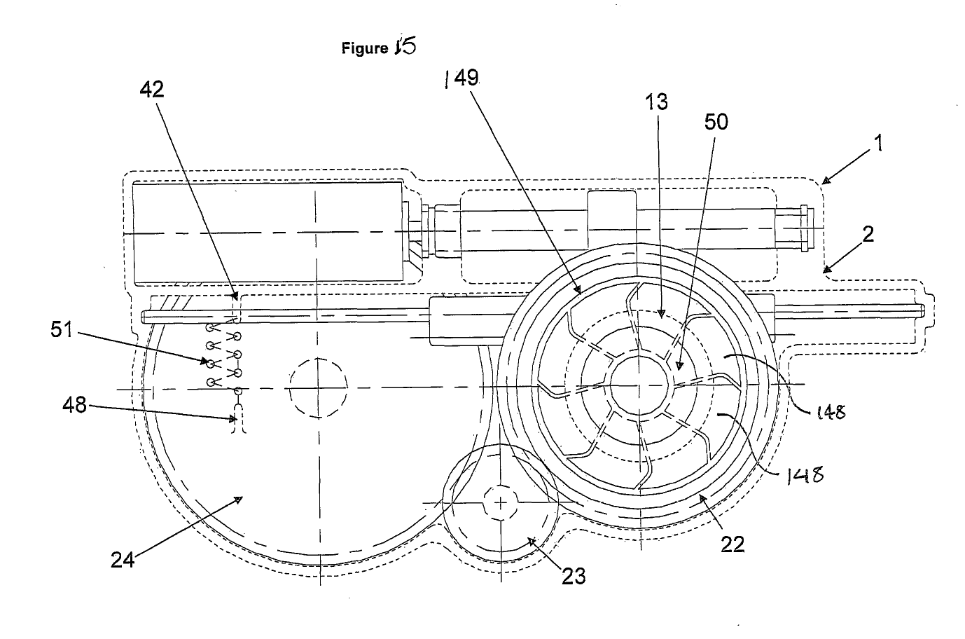

FIG. 15 shows an alternative energy storage means 51.

This is shown in a gearbox according to the second embodiment, although it will be appreciated that it can be utilised with other embodiments of the invention.

The energy storage means 51 can work alone or with another energy storage means. The energy storage means 51 is coupled between a gear, such as gear 24, and a portion 42 of the casing 2 or tube or bar 15. The energy storage means 51 could be connected to any of the gears, however for illustration purposes in this figure it has been show attached to gear 24.

As the gear 24 moves to a first position, the energy storage means stores energy from the system. As the gear 24 moves to a second position, the energy that has been stored is released into the system. For example, if the energy storage means 51 is an extension spring, movement of gear 24 in an anti-clockwise direction will extend the spring to store energy in the spring which can be released when the gear turns in a clockwise direction. The energy storage means in this case can be any electrical, mechanical and/or a fluid means such as hydraulics or pneumatics.

As well as storing and releasing energy, the energy storage means 51 can minimise play or back lash within the system such that the system is efficient and accurate whilst being responsive, and can assist in providing optimum meshing of components in the gearbox. This can reduce the wear of the system and further minimise the noise of the system.

Where the energy storage means 51 is attached to the tube or bar 15 as the gear 24 rotates, force from the energy storage means 51 will be exerted on the tube or bar 15 in an increasing manner with relation to the movement. Therefore as the gear 24 moves anti-clockwise, the force which the tube or bar 15 exerts on the meshed arrangement between the toothed section 12 and the gear 13 increases. It will be appreciated that selection of the energy storage means or position can store and release energy for different movement of the gear 24.

The relationship the energy storage means 51 has with the drive train and actuator further ensures that the accuracy and responsiveness of the output means is always optimised and the maximum performance of the gearbox can be maintained throughout its lifecycle.

As with the embodiment of FIG. 14, the force exerted by the energy storage means 51 minimises back lash and/or play, and can reduce noise and wear.

FIG. 15 shows a second energy storage means. In this example, a disk 149 is provided on a shaft, the disk 149 having a plurality of tines 148. As the shaft is rotated, thereby rotating the centre portion of the disk 149, the outer ends of the tines may be retained against a stop fixed with respect to the casing. In this way, energy is stored in the tines 148, similar to a leaf spring. As the shaft is rotated in the opposite direction, the energy stored in the tines 148 due to the previous movement of the inner ends of the tines 148 with respect to the outer ends of the tines 148 will be released as the inner ends of the tines 148 move back towards their original position with respect to the outer ends of the tines 148.

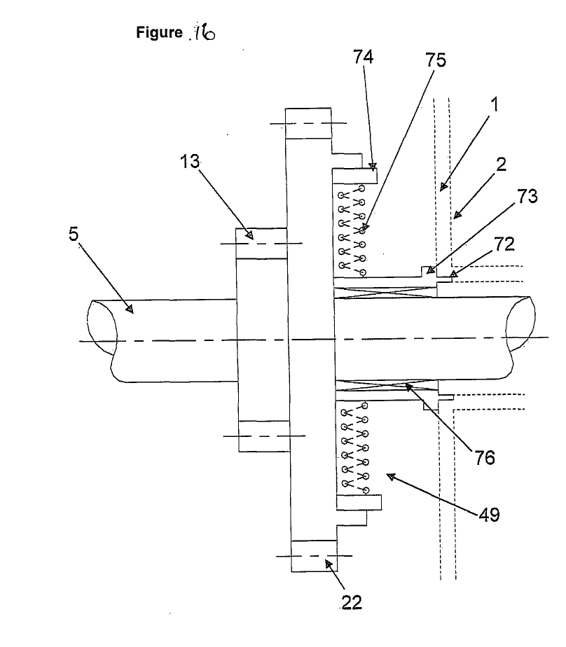

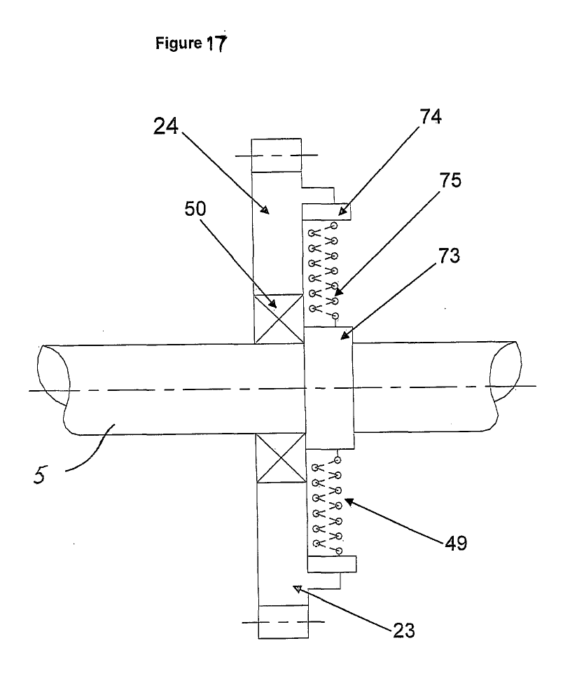

Further examples of energy storage systems that store energy during rotation of a shaft in one direction to be released when the shaft moves in the opposite direction are shown in FIGS. 16 to 17. These can be used in combination with any of the energy storage means described above, or alone.

The energy storage means, such as a spring 49, is connected between a rotatable component and a fixed component. As with the energy storage means 51, the rotation of the rotatable component in one direction will store energy in the energy storage means 49 which can be released when the rotatable component is rotated in the opposite direction.

For example, the rotation of the rotatable component in one direction may expand a spring, which compresses as the rotatable component is rotated in the opposite direction to release energy stored in the spring during its expansion. In preferred examples, the spring 49 or other energy storage means is connected between an inner ring and an outer ring, one of which is rotatable with respect to the other.

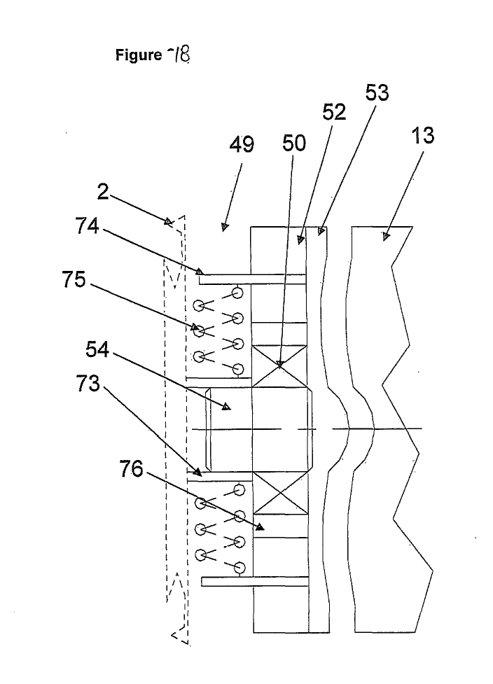

In FIG. 16, the inner ring 73 is held with respect to the gearbox housing 2 around a shaft 5, with the outer ring 74 being fixed to a gear 22 fixed with respect to the shaft 5. In FIG. 17, the gear 24 is rotatably mounted with respect to a shaft via bearing 50, and accordingly the inner ring 73 can be integral with or fixed with respect to the shaft, and the outer ring 74 fixed to the gear 24. In the example shown in FIG. 18, the inner ring 73 is formed as part of the gearbox housing 2, and the outer ring 74 is formed as part of a cam plate 52 rotatably mounted with respect to the gearbox housing 2. The cam plate 52 can be selectively coupled to a gear 13 via a cam surface 53 which enables the selective rotation of the cam plate 52 with the gear 13, for example so that initial rotation of the gear 13 does not cause movement of the cam plate 52, but continued rotation of the gear 13 affects rotation of the cam plate 52.

In more detail, considering the embodiment shown in FIG. 16, the shaft 5 includes an outer bearing 76 over which the inner ring 73 is placed. The bearing 76 allows the shaft to rotate freely. The shaft is shown to extend through an opening of the gearbox housing 2 to which the inner ring 73 is attached to prevent relative movement between the inner ring 73 and the gearbox housing 2. However, it will be appreciated that the shaft 5 is not required to exit the housing 2. An outer ring 74 is connected to the gear 22 which is attached to the shaft 5. In this way, the shaft 5, gear 22, gear 13 and outer ring 74 will rotate together with respect to the inner ring 73. An energy storage means in the form of a spring 75 is connected between the inner and outer rings 73, 74. The rotation of the shaft 5, gear 22, gear 13 and outer ring 74 in one direction will extend the spring 75. The rotation of the shaft 5, gear 13, gear 22 and outer ring 74 in the opposite direction will compress the spring 75. The extension of the spring will cause energy to be stored in the spring which can be released as the spring is compressed. In this case, rotation of the shaft 5, gear 13, gear 22 and outer ring 74 in the first direction will store energy in the spring 75, which is used to assist rotation of the shaft 5, gear 22 and outer ring 74 in the second direction. It will be appreciated that the spring or other energy storage compound may be selected to store energy when compressed and release energy when expanded.

In FIG. 17, the inner ring 73 is integrally formed with or attached to the shaft so as to move with the shaft. The gear 24 is rotatably mounted on the shaft using bearing 50. The outer ring 74 is connected to the gear 24 so as to rotate with the gear 24. As with the example in FIG. 16, a spring 75 is connected between the inner and outer rings 73, 74. Relative rotation of the gear 24 and shaft in one direction will extend the spring 75, relative rotation in the opposite direction will compress the spring 75. As described with respect to FIG. 16, the extension and compression of the spring 75 can store and release energy.

As a further example, the spring 75 can consist of fixed end tines which as described above act like leaf springs. The tines connect the inner ring 73 and outer ring 74 with the inner ring attached to the shaft and an outer ring 74 attached to a gear. The gear and shaft can be any gear in the drive train and/or actuator elements and in this case can be gears 13 and/or 22 and/or 23 and/or 24 connected to the outer ring and their respective shafts attached to the inner ring. The gears can or rotatable components can be coupled to a rotatable or fixed shaft depending on the application.

If the shaft is fixed then and for example the gear 22 and gear 13 are rotatably mounted to the shaft by bearings. As the gears 22 and 13 rotate the outer ring 74 of the element to which the gears are attached rotates.

The tines have at least one angled shape such as a change of direction or at least one fold.

In this case gear 22 and 13 rotates in one direction and energy is placed into the tine which is released when the gear 22 and 13 rotate in the opposite direction.

If the shaft is rotationally mounted, the gear, such as gear 22, can be rotatably mounted on the shaft as described above then the shaft and gear can move relative to each other.

As the gear 13, which in this case may be integrated to the rotatably mounted shaft, rotates resulting from the motion of the toothed drive rack, the tines that connect the shaft to the gear 22 will begin to absorb the motion and force input by gear 13.

Once the absorbed motion and force increases sufficiently, the gear 22 will start to rotate. When the gear 22 rotates in the opposite direction the shaft and the gear 13 can remain stationary and/or rotate in the same or opposite directions and as such add and release tension into the system via the tines.

As a further example the tines with the inner and outer ring can be applied to the gear 24 which is rotably mounted on the shaft 5. The outer ring is attached to the gear 24 and the inner ring is attached to shaft 5 which is able to rotate in the same or opposite direction to the gear.

As the actuator element adds force and motion into the drive train, the gear 24 will be rotated which allows the tines to absorb energy and be tensioned. Once the tension has overcome the effort required to rotate the shaft 5 the shaft 5 will rotate in the same direction as the gear.

However if the effort required to rotate the shaft changes, then the shaft will stop rotating until such time as the gear 24 has rotated sufficiently to add more energy and as such tension into the tines.

Therefore the gearbox can be used to provide a tensioned output and thus remains self-locking but instead of the shaft being stationary the shaft is able to move depending on the tension in the tines relative to the load on the shaft. As such the gearbox can be said to also be self-locking between adjustable limits.

The gearbox through the input of the actuator element can be used to input and remove tension from the system as described above. This allows the gearbox to be used in applications where tension and/or the ability to control tension is required.

All the above can be applied to any gear and can place a positive charge in the gearbox 1 and thus remove play and backlash as well as improve accuracy and optimise meshing arrangements and wear.

In FIG. 18, the inner ring 73 is formed as part of the gearbox housing 2. A shaft 54 is fixedly mounted within the inner ring 73. A cam plate 52 having a cam edge 53 and an outer ring 74 is rotatably mounted on the shaft 54. It will be appreciated the outer ring 74 may be integral with or attached to the cam plate. As with the examples described with respect to FIGS. 16 and 17, the storage element such as a spring 75 is connected between the inner and outer rings 73, 74 such that a relative rotation of the inner and outer rings in one direction will extend the spring, and relative rotation in the opposite direction will compress the spring. This can be used to store and release energy.

The cam edge 53 fits a cam edge of the gear 13, the gear 13 being able to rotate independently of the cam plate 52. By designing the cam edge of the gear 13 such that it can engage the cam plate 52 via the cam edge 53 at any point when moving in a first direction, at a predetermined point the cam edge of the gear 13 can contact the cam edge 53 of the cam plate 52 to start to rotate the cam plate 52. This differs from the arrangement shown in FIGS. 16 and 17 in which the forward motion of the shaft and/or gears causes relative movement of the inner and outer rings 73, 74 and consequent extension or compression of the spring. In the example shown in FIG. 18, the cam plate is only rotated over certain portions of rotation of the gear. When the cam plate rotates in the opposite direction or further in the same direction, the stored energy can be released to the gear 13. This can be used to add a braking effect on the gear 13, and to store the resulting energy that can be replaced to assist rotation. This can therefore provide a brake and boost system which is of particular benefit at the start and end of a cycle.

The energy storage means of FIGS. 16 to 18 can be used alone or in combination with other energy storage means.

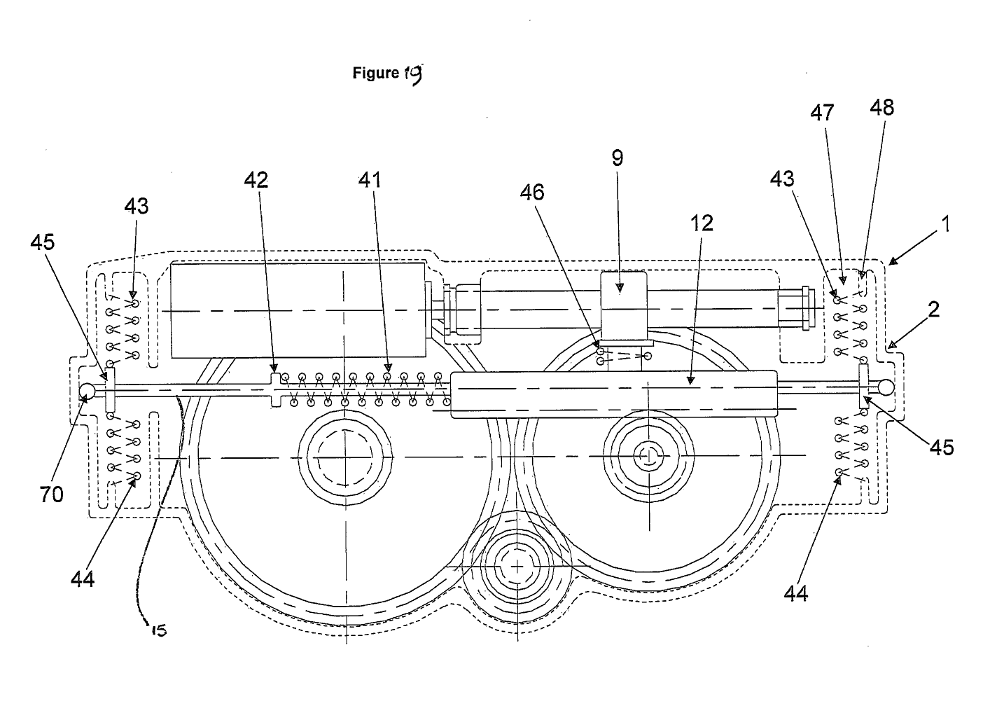

FIG. 19 shows an example of a gearbox 1 including biasing means, such as springs 43, 44, 46 for biasing components within the gearbox 1, for example the tube or bar 15 and the toothed section 12. It will be appreciated that biasing means other than springs may be used, for example pneumatic or hydraulic biasing means, that the biasing means can be used to selectively bias some or all of the components in the gearbox 1 and not merely those components shown in FIG. 19, and that the biasing means can be used in any embodiment of the present invention.

In the embodiment shown in FIG. 19, a spring 46 is provided between the drive rack nut 9 and the toothed section 12. This spring 46 acts to bias the toothed section 12 towards and into meshed engagement with the gear 13, although could be arranged to bias the toothed section 12 away from meshed engagement with the gear 13. In this example, the toothed section 12 is mounted on the tube or bar 15. The tube or bar 15 is also mounted using springs 43, 44 provided at either end to permit lateral movement of the tube or bar 15. The springs 43, 44 are mounted between a portion 45 of the tube or bar 15 and the gearbox housing 2. As shown, rollers 70 may be provided at one or both ends of the tube or bar 15 to prevent longitudinal movement of the tube or bar 15, whilst permitting the desired lateral movement. For example, the tube or bar 15 can be held parallel with the centre or axis of the leadscrew 8.

It will be appreciated that each of the biasing means may be attached to components of the gearbox as necessary for the operation, and that each of the biasing means may be the same or different, in terms of the force provided or their type.

In the example shown in FIG. 19, the biasing means act to ensure a constant force is exerted between the toothed section 12 and the gear 13, and between the drive rack nut 9 and the leadscrew 8. This ensures that these remain in the desired meshed arrangement during operation. The biasing means also assists in the reduction of vibration of the components of the gearbox, and the reduction of any vibration on the components transmitted externally through the gearbox housing 2 or the output shaft 5. The biasing can also reduce noise. The constant pressure applied between the components through the use of the biasing means can assist performance, response and accuracy of the system, and can also help assist with increasing the life of the components through reduced wear. The biasing is able to remove of excess play within the system and can help avoid damage to the components. At the same time and during operation, if too great a force is generated in the gearbox the force of the biasing means may be overcome to avoid damage to the components. For example, the force of the biasing means may be overcome to separate the toothed section 12 from the gear 13 if there is too great a force applied between the toothed section 12 and the gear 13, allowing the toothed section 12 and gear 13 to separate rather than damaging the respective teeth.

Thus the at least one energy means is capable of recovering, storing and using energy as well as expanding and enhancing the performance of the at least one gearbox 1. However the at least one energy means can act with all the at least one energy means described herein in whole and/of in part. Therefore the at least one upper and lower energy means 43 and 44 as shown in FIG. 19 respective to the interaction of the at least one energy means with the at least one tube 15 can be varied with relation to the at least one energy means not only to further enhance performance and other aspects referenced above such as optimising the at least one meshed relationship and/or continuous adjustment to wear irrespective of the system loads but also and with or without the inclusion of the at least one energy means 46 the alignment of the toothed section 12 and the at least one gear 13 and between the leadscrew 8 and drive rack nut 9 can be optimised in at least one axis and typically multiple axes where applicable.

This optimised multi-axes ability by also used throughout the drive trains means and the actuators such that and for instance each of the at least one gears can be aligned and meshed with respect to at least one other gear and/or the toothed section 12 in multiple axes and thereby further optimising the wear reduction and/or performance of the system for specific and lifecycle operation irrespective of load and/or movement relationship.

The relationships between all the energy means in whole and/or in part as described herein can directly and/or indirectly add to and/or reduce the contract pressure in at least one meshed relationship with the gearbox 1 and as referenced herein.

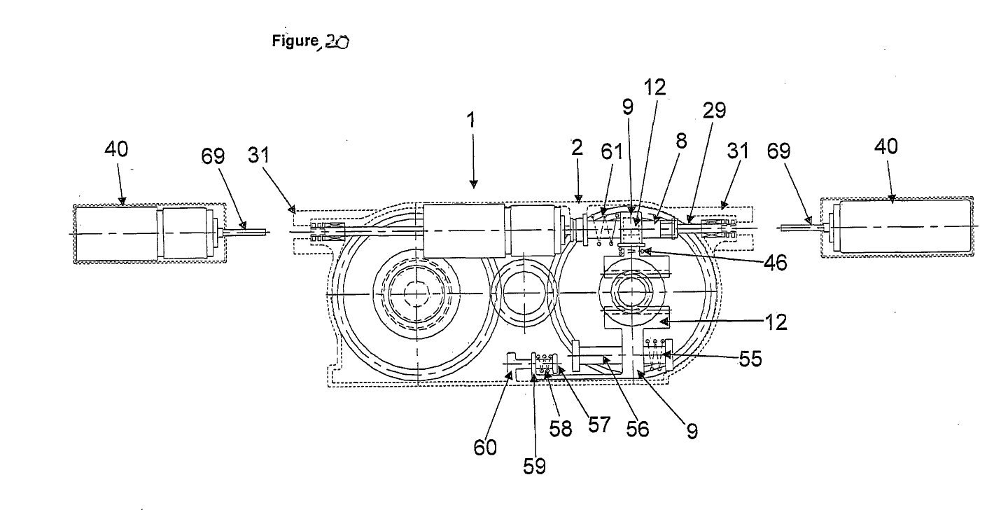

FIG. 20 illustrates an expandable means for at least one gearbox 1. This format can be applied to all variations of the invention.

As described with respect to FIGS. 12 and 13, the gearbox 1 is shown to include two extension means 31 allowing two external actuators 40 to attach to the actuator 6 and/or the leadscrew 8. The external actuators 40 can provide force to the gearbox 1, for example where the external actuator 40 is a motor, or may recover energy from the gearbox 1, for example where the external actuator is a dynamo.

Where plural external actuators 40 are provided, these may be of the same type or different type. For example, two external actuators may be provided, one being a motor to input energy to the gearbox 1, the other being a dynamo to store energy.

In FIG. 20, an energy storage means 61 is located about the leadscrew 8, acting on the drive rack nut 9. Therefore, as the drive rack nut 9 moves in the first direction, the energy storage means 61 can store energy which is released when the drive rack nut 9 moves in the opposite direction, as described previously.

In this example, a secondary lower actuator system (including drive rack nut 9 and toothed section 12) is provided. The secondary system has no active leadscrew 8 and instead has a dummy leadscrew 56 which features an energy storage means 55.

As the upper system moves in the first direction to move the gear 13, the lower system moves in the opposite direction due to interaction with the rotating gear 13. The lower drive rack nut 9 features a rack section 59. The rack section 59 is attached to the drive rack nut 9 and as the drive rack nut 9 moves so the rack section 59 moves. The rack section 59 is movably mounted on a shaft 57 which is in turn held in the gearbox housing 2. The rack section 59 and/or the shaft 57 can feature lubrication and/or bearing means such that the rack section 59 slides along the axis of the shaft section 57 and preferably in a low friction manner.

A further energy storage means 58, such as a spring, can be located over the shaft 57. The system is such that as the upper toothed rack section 12 moves to the first position so the lower drive rack nut 9 moves to the second position and as such can store and/or recover energy via the energy storage means 55. As such the lower drive rack nut 9 moves to the second position, so the rack section 59 moves and thus the energy means 58 stores and/or recovers energy.

Therefore as the upper toothed drive rack 9 and associated toothed section 12 move to the second position so the lower toothed drive rack nut 9 and associated toothed section 12 moves to the first position whereby the energy that has been stored and/or recovered by the energy storage means 55 and 58 is released and able to exert force onto the rack section 59 and the lower toothed drive rack nut 9 and as such place force and motion into the system to reduce the overall power consumption.

This also means that the system is further positively changed and as such continuously adjusts to wear of the at least one gearbox 1 lifecycle and furthermore the system allows the at least one meshing relationship in the system to be optimised, and back lash and/or play in the system to be reduced and or eradicated The energy storage means described herein can be used with other energy storage means herein.

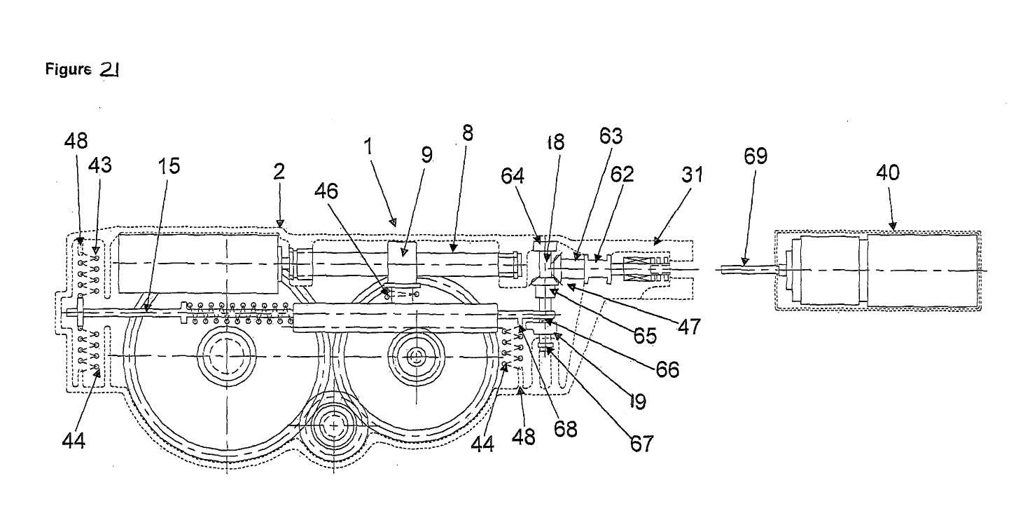

FIG. 21 shows a disconnection means that can be used to disconnect the system, for example, in case of emergency. This is particularly useful where the gearbox is used in medical applications, such as in CPR equipment or any other device where emergency disconnection is required/desired. The embodiment can include all the functions and features of any gearbox described.

The disconnection means may be used in any embodiment of the present invention.

The disconnection means is located at the right hand side in FIG. 21. It will be appreciated that multiple disconnection means can be used, for example one at each end of the tube or bar 15.

The disconnection means comprises a means for moving the tube or bar 15 supporting the toothed section 12 away from the gear 13 to bring the toothed section 12 out of meshed engagement with the gear 13, thereby disconnecting the output shaft 5 from the actuation. The tube or bar 15 is movably connected to a disconnection nut 19 optionally via a biasing means 66. The tube or bar 15 is held in such a manner so as to stop movement in at least one axis, for example using a roller 70 as described with respect to FIG. 19, although it will be appreciated that the tube or bar 15 may be merely supported by nut 19 and limited with relation to the portion 68 and/or the biasing means 66 without bearing on the casing either with or without a roller. The portion 68 also acts with regards to the portion 45 from FIG. 19 and thus also allows the biasing means 44 a connection to the tube or bar 15 and as such the biasing means 44 aids with the function of the tube or bar 66. A disconnection leadscrew 18 is held by a bearing 64, 67, held captive in at least one portion of the gearbox housing 2. The disconnection leadscrew 18 is attached to a first bevel gear 65 in meshed arrangement with a second bevel gear 63 where bevel gear 63 has a bearing portion 62 as either a separate component and/or attached or integrated. The second bevel gear 63 is attached to the extension shaft 29 which is held by a bearing 62 in the gearbox housing 2 as per FIG. 12.

An external actuator 40 as per FIG. 20 which can be an electrical and/or manual actuator such as a handle and/or other suitable device is connected to the extension means 31 to rotate the extension shaft, which causes the second disconnection bevel gear 63 to rotate, this in turn rotates the first bevel gear 65 which in turn rotates the disconnection leadscrew 18. As the disconnection leadscrew 18 rotates, the disconnection nut 9 moves vertically and thus lifts the tube or bar 15.

As the tube or bar 15 moves, the toothed section 12 becomes disconnected from the gear 13.

1. A gearbox comprising:
an actuator;
a leadscrew arranged to be rotated about its axis by the actuator;
a rack nut threadingly engaged with the leadscrew, and arranged such that rotation of the leadscrew drives the rack nut longitudinally with respect to the leadscrew;
a toothed section integral with or coupled to the rack nut for longitudinal movement with the rack nut;
a shaft; and
a gear integral with or coupled to the shaft, and arranged such that rotation of the gear causes rotation of the shaft;
wherein the toothed section is arranged to mesh with the gear such that the longitudinal movement of the toothed section causes rotation of the gear.

2. A gearbox according to claim 1 in which the actuator comprises a motor.

3. A gearbox according to claim 2, in which the motor comprises an electric motor.

4. A gearbox according to claim 1, in which the actuator comprises a manual drive.

5. A gearbox according to claim 1, comprising a plurality of actuators for driving the leadscrew.

6. A gearbox according to claim 1, in which the drive rack nut includes an integral threaded portion that meshes with the thread of the leadscrew.

7. A gearbox according to claim 1, wherein the drive rack nut includes a threaded insert that meshes with the thread of the leadscrew.

8. A gearbox according to claim 1, in which the toothed section is removably attached to the drive rack nut.

9. A gearbox according to claim 8, in which the toothed section is resiliently biased with respect to the drive rack nut.

10. A gearbox according to claim 1, in which the drive rack nut and/or the toothed section are held to permit the generally longitudinal movement in a direction generally parallel to the axis of the leadscrew, but to prevent their twisting with respect to the leadscrew.

11. A gearbox according to claim 10, in which an elongate member is aligned generally with the desired direction of movement of the drive rack nut and/or the toothed section and which is received within a recess of the drive rack nut and/or the toothed section.

12. A gearbox according to claim 1, further comprising an output transmission coupling the shaft to an output shaft.

13. A gearbox according to claim 1, wherein the gearbox includes an energy storage means arranged to store energy during at least part of the rotation of the shaft to be released during another part of the rotation of the shaft.

14. A gearbox according to claim 13, in which the energy storage means comprises a spring.

15. A gearbox according to claim 1, further comprising a second or further actuator, leadscrew, drive rack nut, toothed section and/or gear associated with the shaft may be provided to allow additional drive of the shaft.

16. A gearbox according to claim 1, further comprising one or more sensors to detect operational parameters of the gearbox.

17. A gearbox according to claim 1, further comprising a processor means for controlling the operation of the gearbox.

18. A gearbox according to claim 1, in which the housing comprises a plurality of components that are connectible together.
